(19) United States
(12) Patent Application Publication
(10) Pub. No.: US 2002/0102381 A1
(43) Pub. Date: Aug. 1, 2002

(54) Drywall patch and method

(76) Inventor: Ben B. McClurg, Aloha, OR (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/930,116

(22) Filed: Aug. 14, 2001

Related U.S. Application Data
(60) Provisional application No. 60/225,090, filed on Aug. 14, 2000.

(51) Int. Cl. B32B 3/26

(52) U.S. Cl. 428/78; 428/63

(57) ABSTRACT

A patch for repairing walls, ceilings, and other structural surfaces, including a backing member and a plug secured to and protruding from the backing member. The plug is adapted to substantially conform to and fill in a generally circular hole cut out of a structural surface in an area of the structural surface that is to be repaired. The patch may be provided as part of a patch kit, which further includes a storage/guide device. The storage/guide device includes a hole within which the plug may be inserted to safely store the patch and protect it from damage during transport. The hole in the storage/guide device is also configured to serve as a guide for cutting the structural surface in an area of the structural surface that is to be repaired by application of the patch.

### CROSS-REFERENCE TO RELATED APPLICATION

This application claims priority from U.S. Provisional Patent Application Serial No. 60/225,090, filed Aug. 14, 2000 for a DRYWALL PATCH AND METHOD.

### FIELD OF THE INVENTION

The present invention relates to patches, and more particularly to patches used on drywall.

### BACKGROUND OF THE INVENTION

In a typical building, many of the walls and ceilings are made of drywall. The use of drywall has many advantages such as ease of installation and low cost of materials. However, drywall also has disadvantages. For instance, drywall is easily punctured by a sudden blow to a small area such as from a protruding doorknob on a swinging door. Once drywall is punctured, it is difficult to patch. Prior attempts to create drywall patches resulted in products that were either complex to use, involved removing a large amount of drywall compared to the size of the hole, or left a weak spot in the drywall.

### SUMMARY OF THE INVENTION

The invention includes a patch for repairing walls, ceilings, and other structural surfaces. The patch has a backing member and a plug secured to and protruding from the backing member. The plug is adapted to substantially conform to and fill in a generally circular hole cut out of a structural surface in an area of the structural surface that is to be repaired. The backing member protrudes outward from the plug so that, when the plug is inserted into the hole, the backing member covers a portion of the structural surface surrounding the hole. The patch may be provided as part of a patch kit, which further includes a storage/guide device. The storage/guide device includes a hole within which the plug may be inserted to safely store the patch and protect it from damage during transport. The hole in the storage/guide device is also configured to serve as a guide for cutting a hole out of a structural surface in an area of the structural surface that is to be repaired by application of the patch.

### BRIEF DESCRIPTION OF THE FIGURES

FIG. 1 is a photograph showing an exemplary drywall patch and template.

FIG. 2 is a photograph showing the drywall patch of FIG. 1 in isolation.

FIG. 3 is a photograph showing the template of FIG. 1 in isolation.

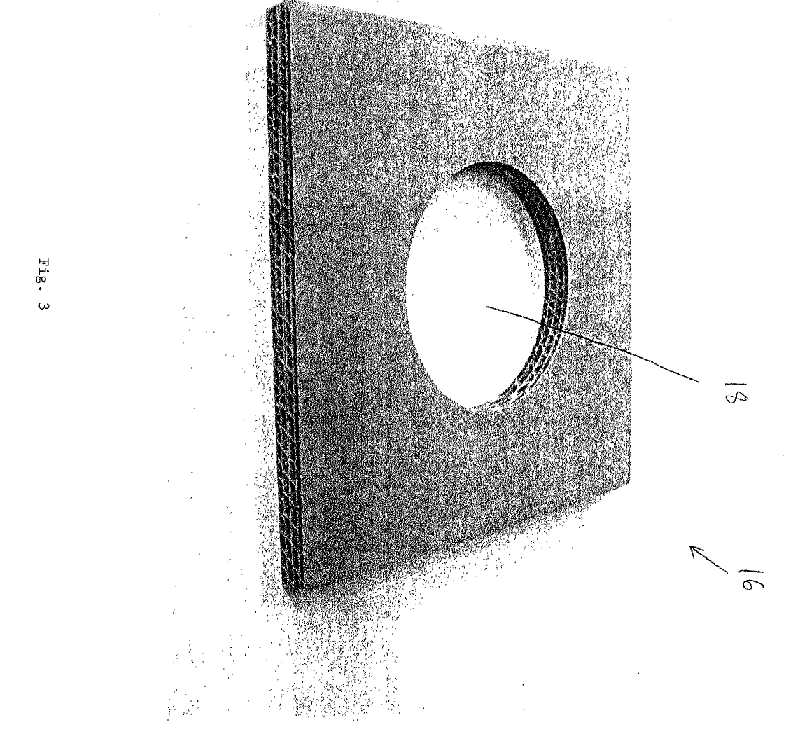

FIG. 4 is a photograph showing the drywall patch positioned in the template from above.

FIG. 5 is a photograph showing the drywall patch positioned in the template from below.

FIG. 6 is a photograph demonstrating use of the template to define an area to be cut out to accommodate fitted application of the drywall patch.

### DISCLOSURE OF THE INVENTION

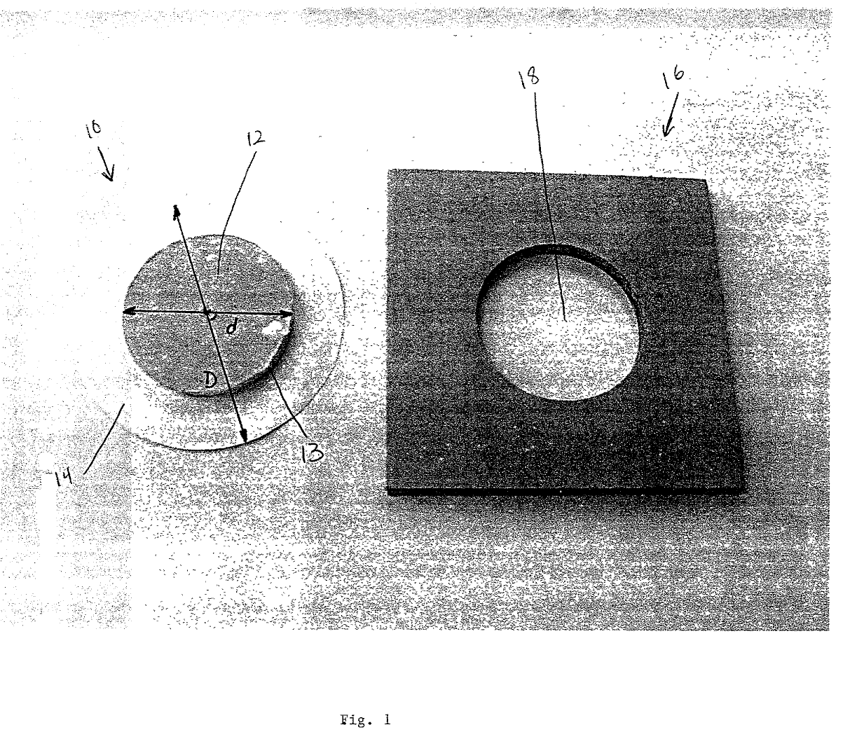

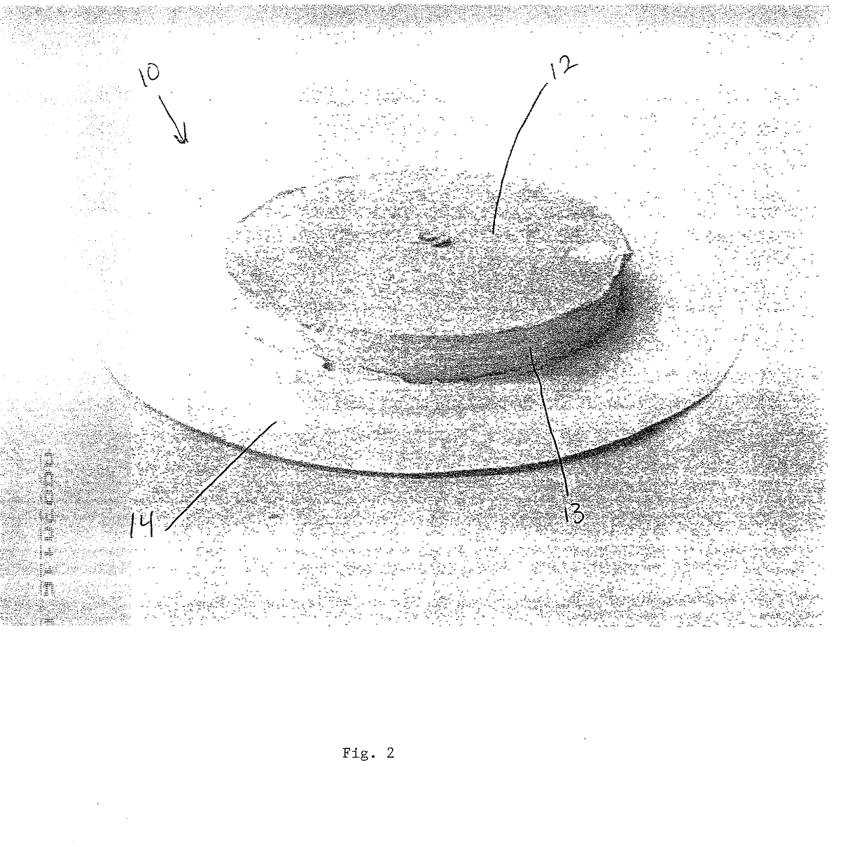

The invention is a drywall patch for patching holes in surfaces made of drywall, Sheetrock®, wallboard, gypsum board, plasterboard, etc. An illustrative example of such a patch is indicated generally at 10 in FIGS. 1-2. As indicated, patch 10 typically has a circular base member 12 with a similarly circular backing member 14. It will be appreciated, however, that drywall patch 10 is not to be limited to the round geometry of the exemplary embodiment. Rather, drywall patch 10, or either of its component parts (e.g. base member 12 and/or backing member 14), may be of any shape suitable to make a repair (e.g. square, rectangular, oval, etc.). It also will be appreciated that the component parts of the patch may be of different geometries (e.g. a circular base member with a rectangular backing member; a rectangular base member with a circular backing member, etc.). Furthermore, the base member 12 and backing member 14 are not limited to the specific size, or relative proportions described herein.

In the present embodiment, base member 12 is cut from a piece of wallboard, typically drywall board of the type including a gypsum center covered on opposite sides by one or more layers of paper. One such drywall board is manufactured by United States Gypsum Company under the trade name Sheetrock®.

As indicated, the base member is circular, typically having a diameter d on the order of approximately 4-inches (which corresponds to the size of a conventional hole saw used to define the hole to be patched). In the exemplary embodiment, the base member is formed from ½-inch drywall, and thus is ½-inch thick. It will be appreciated, however, that base member 12 may be of a different size and/or geometry, and that it may be constructed of a different type of wallboard (e.g. ¼-inch drywall board, ⅜-inch drywall board, etc.).

Backing member 14 is cut from a piece of paper, typically of the type employed as drywall joint tape. As will be appreciated by those skilled in the art, drywall joint tape typically is formed as a cross-fibered paper tape with minimal longitudinal stretch and superior tensile strength. The paper typically is sanded to provide a suitably rough surface, and may be treated (e.g. “sparked”) to ensure absorbance of joint compound and adherence of the paper to the drywall board. Backing member 14 thus is specially adapted to accommodate its use in securing patch 10 over a hole in a wall. One such paper is manufactured by United States Gypsum Company under the trade name Sheetrock®.

The backing member is dimensioned to accommodate placement over the base member to secure the base member to a wall as will be described below. In the present embodiment, backing member 14 is a circular piece of drywall tape having a diameter D of approximately 6⅜-inches. It will be appreciated, however, that the backing member may vary in size or shape so long as the tape is capable of providing adequate coverage of the perimeter of the base member. For example, the backing member may take the form of a ring, circular or otherwise.

Backing member 14 is attached to the base member 12 so that the backing member overlaps the side edge 13 of the base member as shown in FIGS. 1-2. In the exemplary embodiment, backing member 14 is secured to base member 12 using an adhesive such as joint compound (also known as “mastic”). It is contemplated, however, that other methods of attaching the backing member 14 to the base member 12 are within the scope of the invention.

Also shown in FIG. 1 is an exemplary template 16 having an opening 18 which is configured to receive base member 12 of the drywall patch 10. As indicated, template 16 is generally square with a circular central opening 18 which conforms in shape and size to base member 12. It will be noted that template 16 is made from a folded corrugated cardboard which, when folded, has about the same thickness as base member 12. Opening 18 is cut only slightly larger than the diameter of base member 12, thereby allowing the base member 12 to comfortably fit into the opening 18.

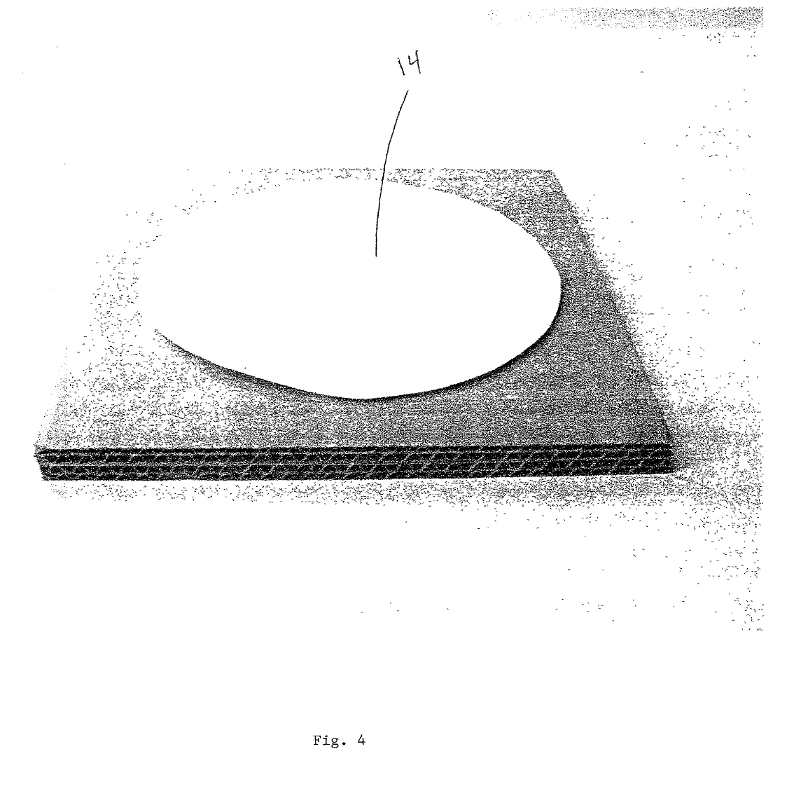

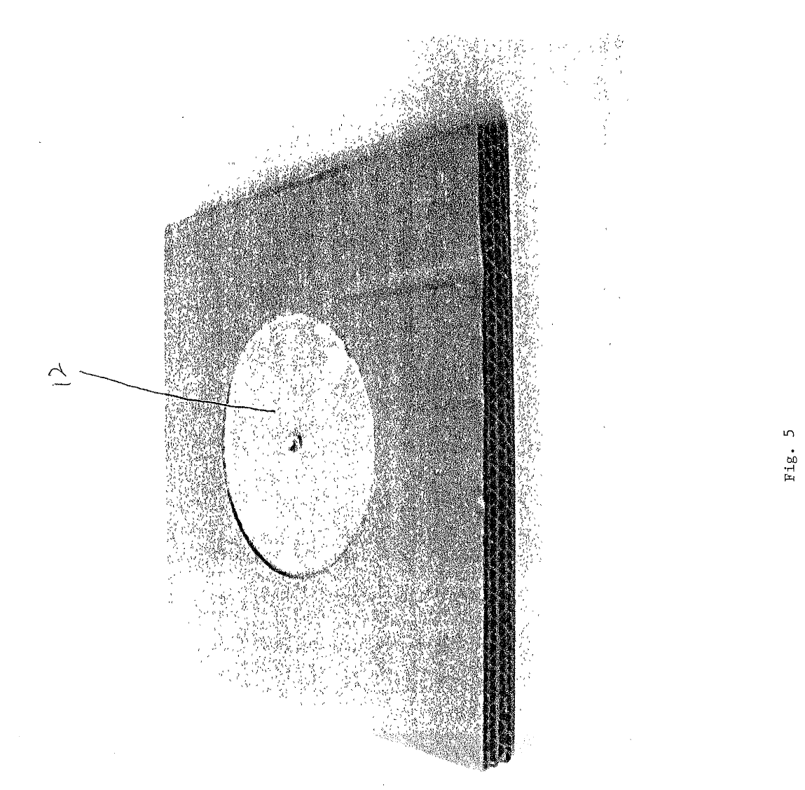

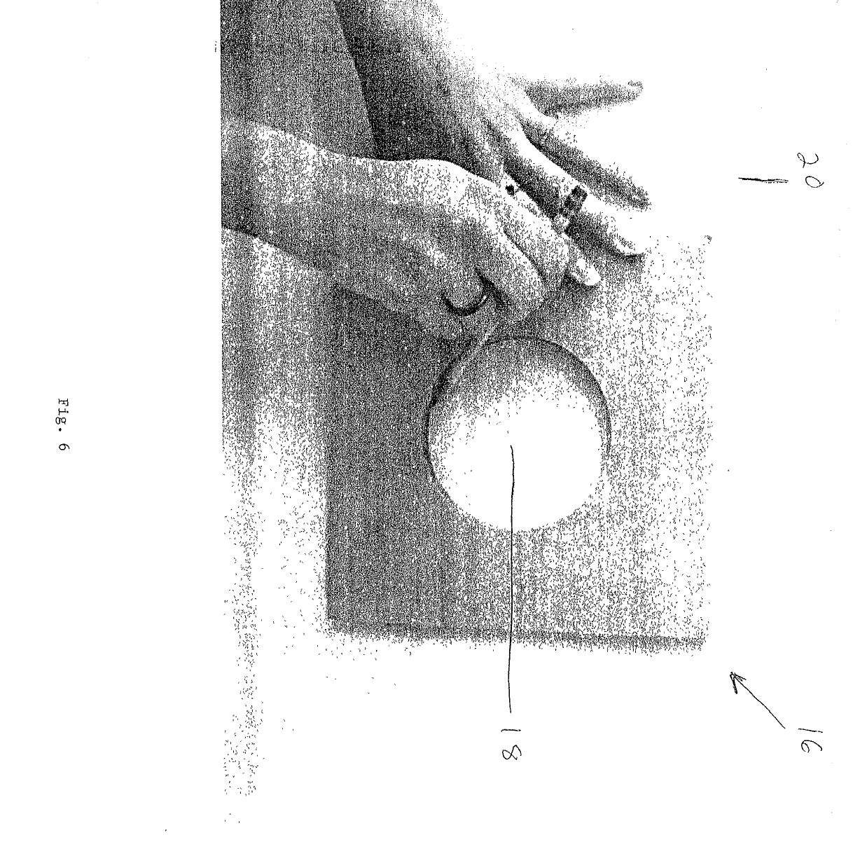

In the exemplary embodiment, the template 16 has two functions. First, as shown in FIG. 6, the template 16 provides the user with a convenient way to outline the hole that will be cut around the damaged portion of the drywall surface 20. Second, as shown in FIGS. 4-5, the template functions as packaging for the drywall patch 10 to strengthen the patch during shipping. It will be appreciated that the drywall base member is somewhat brittle, and that the paper backing member is somewhat susceptible to tearing. The template may be applied to the patch during transit to address both concerns.

The exemplary template 16 is only one of many different possible templates that are within the scope of the invention. The template 16 may be made from many different types of materials that perform one or both of the above-described functions. Furthermore, the template could be of any geometry suitable to perform one or both of the above-described functions.

In order to patch a puncture in a drywall surface 20, the user first draws a circle around the damaged area in the drywall surface 20 using the template 16 as shown in FIG. 6. With a cutting tool (e.g. a hole saw), the user cuts out the circle exposing an opening sized to receive the base member 12. Next, the user applies joint compound (or “mud”) to the edge 13 of base member 12 and then inserts the base member into the opening in drywall surface 20. The user then applies additional joint compound to the outer surface of backing member 14. The joint compound is applied evenly across the surface of the patched area and smoothed over the surface with a putty knife or the like. After sufficient drying time, the user lightly sands off any raised edges to produce a smooth transition from the patched area to the rest of the drywall surface 20. Texture then may be added as desired.

The aforementioned exemplary method is but one method of using the drywall patch to patch drywall. However, it is contemplated that the patch may be applied using other methods that may include more or less steps then the above method and/or where the steps are rearranged in a different order. For instance, the user may put one coat of joint compound over the backing surface, let it dry, sand, then add another coat of joint compound, let it dry, sand, etc.

I claim:

1. A patch for repairing walls, ceilings, and other structural surfaces, comprising:
a backing member; and
a plug secured to and protruding from the backing member, the plug being adapted to substantially conform to and fill in a generally circular hole cut out of a structural surface,
where the backing member protrudes outward from the plug such that, when the plug is inserted into the hole, the backing member covers a portion of the structural surface surrounding the hole.

2. A patch kit for repairing walls, ceilings, and other structural surfaces, comprising:
a structural surface patch, including:
a backing member; and
a plug secured to and protruding from the backing member, the plug being adapted to substantially conform to and fill in a generally circular hole cut out of a structural surface in an area of the structural surface that is to be repaired, where the backing member protrudes outward from the plug such that, when the plug is inserted into the hole, the backing member covers a portion of the structural surface surrounding the hole; and
a storage/guide device, including a generally planar member with a hole provided therethrough, the hole being of greater depth than the plug so as to accommodate full insertion of the plug for storage purposes, the generally planar member being sized so that the backing of the structural surface patch does not extend beyond the generally planar member when the plug is received within the hole in the generally planar member, the hole in the generally planar member being further configured to provide a guide for cutting the hole in the structural surface.
